(19) United States
(12) Patent Application Publication
(10) Pub. No.: US 2018/0076634 A1
(43) Pub. Date: Mar. 15, 2018

(54) CHARGING METHOD AND ELECTRONIC APPARATUS

(71) Applicant: MediaTek Singapore Pte. Ltd., Singapore (SG)

(72) Inventor: Shao-dong ZHANG, Shenzhen City (CN)

(21) Appl. No.: 15/673,807

(22) Filed: Aug. 10, 2017

(30) Foreign Application Priority Data
Sep. 9, 2016 (CN) 201610816471.9

(51) Int. Cl. H02J 7/00

(52) U.S. Cl. CPC H02J 7/007

(57) ABSTRACT

A charging method is provided in the invention. The charging method includes the steps of selecting a charging scheme from at least one of a first charging scheme and a second charging scheme, wherein the speeds of the first charging scheme and the second charging scheme are different; and charging a battery according to the selected charging scheme. An electronic apparatus is provided in the invention. According to the charging method, the invention meets the user's need for fast charging while decreasing the degradation of the battery's ability to hold a charge and slowing down the battery's aging process.

### CROSS REFERENCE TO RELATED APPLICATIONS

This Application claims priority of China Patent Application No. 201610816471.9, filed on Sep. 9, 2016, the entirety of which is incorporated by reference herein.

### BACKGROUND OF THE INVENTION

### Field of the Invention

The invention generally relates to charging technology, and more particularly, to a charging method and an electronic device.

### Description of the Related Art

In consumer electronics, devices that require batteries are ubiquitous. In order to improve the user's experience, technology that allows fast-charging of batteries is gaining in popularity. Fast charging refers to a method of charging a battery wherein the charging speed is faster, the time required for charging is shortened, and the charging current is larger relative to normal charging.

As batteries undergo iterations of charge and discharge cycles, they deteriorate faster and gradually lose their ability to hold a sufficient charge. A battery that routinely undergoes faster charging speed with a larger charging current will age faster and capacity of the usable power of the battery will be decreased. Therefore, while fast-charging can be convenient in that it shortens the time required to charge the battery, the effective lifespan of the battery suffers as a result.

### BRIEF SUMMARY OF THE INVENTION

A charging method and an electronic device are provided to overcome the problems mentioned above.

An embodiment of the invention provides a charging method to resolve the problems mentioned above. The charging method comprises the steps of selecting a charging scheme from at least one of a first charging scheme and a second charging scheme, wherein charging speed of the first charging scheme is different from charging speed of the second charging scheme; and charging a battery according to the selected charging scheme.

The step of selecting the charging scheme from at least one of the first charging scheme and the second charging scheme may comprise the steps of receiving a selection instruction input by the user; and selecting the charging scheme that corresponds to the selection instruction.

The step of receiving the selection instruction input by the user may comprise the step of receiving the selection instruction input by the user through a touch screen and/or a microphone.

The step of receiving the selection instruction input by the user may comprise the step of obtaining the status of a switch on a charger, wherein the switch is configured to select the charging scheme, and taking the status as the selection instruction, when the selection instruction of the user cannot be received, the input selection instruction is invalid, or the charging mode is smart charging mode.

The step of selecting the charging scheme from at least one of the first charging scheme and the second charging scheme may comprise the step of matching at least one of a current time, a current location, a user habit, and a battery loading with the default settings of each charging scheme to select the charging scheme when the selection instruction of the user cannot be received, the input selection instruction is invalid, or the charging mode is smart charging mode.

The step of selecting the charging scheme from at least one of the first charging scheme and the second charging scheme may comprise the step of matching at least one of the current time, the current location, the user habit, and the battery loading with the default settings of each charging scheme to select the charging scheme.

The step of selecting the charging scheme from at least one of the first charging scheme and the second charging scheme may comprise the steps of selecting the charging scheme according to the status of a switch on a charger, wherein the switch is configured to select the charging scheme.

Another embodiment of the invention provides an electronic apparatus to resolve the problems mentioned above. The electronic apparatus comprises a controller, a charging circuit, and a battery, wherein the controller, the charging circuit, and the battery are connected to each other. The controller selects a charging scheme from at least one of a first charging scheme and a second charging scheme and controls the charging circuit according to the selected charging scheme to charge the battery, wherein charging speed of the first charging scheme is different from charging speed of the second charging scheme.

The electronic apparatus further comprises a touch screen and a microphone. The controller receives the selection instruction input by the user through the touch screen and/or the microphone to select the charging scheme that corresponds to the selection instruction.

The controller matches at least one of the current time, the current location, the user habit, and the battery loading with the default settings of each charging scheme to select the charging scheme.

The advantage of the invention is that the charging scheme can be selected from at least two charging schemes with different speeds according to different situations. When the user needs fast charging, the fast charging scheme will be selected. In other situations, when the user is not concerned with the charging speed, the slow charging scheme will be selected. Therefore, when the user needs fast charging, the fast charging scheme will be adopted according to the user's requirements, and during a non-fast charging time, the slow charging scheme will be adopted to decrease the degradation of the battery and slow down the battery's aging.

### BRIEF DESCRIPTION OF THE DRAWINGS

The invention will become more fully understood by referring to the following detailed description with reference to the accompanying drawings, wherein:

FIG. 1 is a flow chart illustrating the charging method according to a first embodiment of the invention;

FIG. 2 is a flow chart illustrating the charging method according to a second embodiment of the invention;

FIG. 3 is a flow chart illustrating the charging method according to an embodiment of the invention;

FIG. 4 is a schematic diagram of the electronic apparatus according to a first embodiment of the invention;

FIG. 5 is a schematic diagram of the electronic apparatus according to a second embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

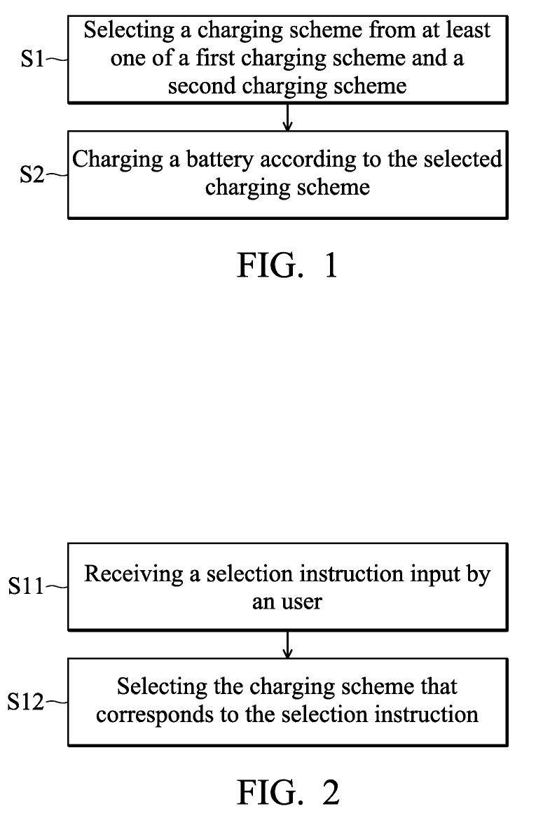

FIG. 1 is a flow chart illustrating a charging method according to a first embodiment of the charging method of the invention. As shown in FIG. 1, the first embodiment of the charging method of the invention includes the steps below.

S1: A charging scheme is selected from at least of a first charging scheme and a second charging scheme. The charging speed of the first charging scheme is different from the charging speed of the second charging scheme. Generally speaking, the battery used to charge and discharge is a lithium battery, or another type of rechargeable battery, such as a nickel-metal hydride battery, a nickel-cadmium battery, and so on. The invention uses a lithium battery as an example, but the invention should not be limited to this. The different charging speeds for different charging schemes means that the different charging schemes may have different charging speeds in the constant-current state, but the invention should not be limited to the charging state, i.e. the invention also can be applied to other charging states.

In general, the charging schemes may be selected via many ways, e.g. the charging schemes may be selected according to the instruction input by the user, or the charging schemes may be selected according to one of the current time, current location, user habit, and battery loading, wherein the instruction input by the user may have a higher priority than others.

S2: the battery is charged according to the selected charging scheme.

In an embodiment of the invention, the charging scheme is selected by the controller, and then the controller may send the corresponding control instruction to the charging management circuit according to the selected result. Then, the charging management circuit may charge the battery according to the control instruction. In another embodiment of the invention, the charging scheme is selected by the controller, and then the controller may send the selected result to the charging management circuit. Then, the charging management circuit may charge the battery according to the selected result. In another embodiment of the invention, the charging scheme may be selected by another device, e.g. the charging management circuit may directly select the charging scheme by itself.

According to the above embodiments of the invention, the fast charging scheme may be selected to meet the user's requirements. In some situations, the slow charging scheme may be selected when the user does not require fast charging. The slow charging scheme has the advantages of mitigating the decrease of the battery's usable capacity, and slowing down the battery's aging process as well.

FIG. 2 is a flow chart illustrating another charging method according to a second embodiment of the invention. As shown in FIG. 2, the second embodiment of the charging method of the invention is based on the first embodiment of the charging method of the invention. Step S1 further includes:

S11: the selection instruction input by the user is received.

Selection instruction input by the user through at least one of the touch screen, microphone or the keyboard may be received.

When the user inputs the selection instruction via the touch screen, the user may input the selection instruction by clicking the selected charging scheme in the pop-up menu which is displayed when the charger is plugged in. The user also may input the selection instruction by clicking an icon that corresponds to the selected charging mode in a pull-down shortcut-menu, or by using the charging control application (through the default menu) when the mobile phone is plugged into the charger or a computer.

The user may also input the selection instruction with a voice command through the microphone, wherein the selection instruction needs to be processed through voice recognition. The user may also input the selection instruction through a keyboard.

S12: the charging scheme that corresponds to the selection instruction is selected.

In an embodiment of the invention, a switch is installed on the charger to select the charging scheme. In the embodiment, the status of the switch can be obtained and the corresponding charging scheme is selected according to the status.

The embodiment in the above paragraph may be combined with the first embodiment of the charging method of the invention and the second embodiment of the charging method of the invention. When the embodiment is combined with the second embodiment of the charging method of the invention, the priority of the switch which is utilized to select the charging scheme is lower than the selection instruction of the user, i.e. only when the selection instruction of the user cannot be received, the input selection instruction is invalid, or the charging mode is smart charging mode, the status of the switch can be obtained and the corresponding charging scheme is selected according to the status.

In an embodiment of the invention, the charging scheme may be selected through a smart selection. In the smart selection, at least one of these parameters, such as the current time, current location, user habit, and battery loading, is matched with the default settings of each charging scheme to select a charging scheme. The settings may be set by default, or matching rules set by the user, or learned and derived according to the user's selection history of previous selections of the charging methods. For example, at night, the charging scheme with a slow charging speed may be selected, but in the daytime, the charging scheme with a fast charging speed may be selected; or at home, the charging scheme with a slow charging speed may be selected, but in the workplace, the charging scheme with a fast charging speed may be selected. When multiple parameters are utilized to be matched with the settings, different parameters may have different priorities or may have the same priority.

The embodiment in the above paragraph may be combined with the first embodiment of the charging method of the invention and the second embodiment of the charging method of the invention. When the embodiment is combined with the second embodiment of the charging method of the invention, the priority of the smart selection may be lower than the selection instruction of the user, i.e. only when the selection instruction of the user cannot be received, or the input selection instruction is invalid, the smart selection can be selected to select the charging scheme. When the charging mode is smart selection, the smart selection will be performed directly without receiving a selection instruction input by the user.

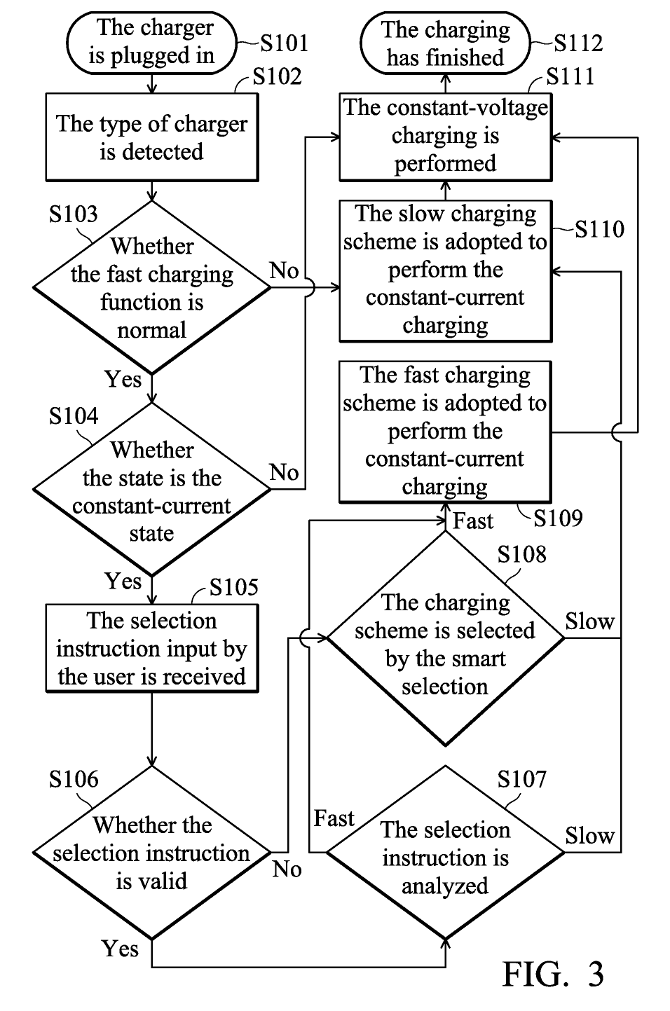

For example, as shown in the accompanying FIG. 3, in an embodiment of the invention, the charging scheme is selected through the user's selection and the smart selection, and the charged battery is a lithium battery. In the constant-current state, the currents of the different charging schemes are different, but in the constant-voltage state, the currents of the different charging schemes are the same. In the embodiment, the method comprises the steps as follows.

S101: The charger is plugged in.

S102: The type of charger is detected.

The fast charging function of the charger is tested to check whether the fast charging function is normal. The abnormality of the fast charging function may be that the charger does not support the fast charging function, or the charger supports the fast charging function, but the fast charging function is presently not operable, e.g. the charger is broken, the temperature is too high, the power is too high, or other factors that are restricting the charger from performing the fast charging function.

S103: The method determines whether the fast charging function is normal.

If “yes”, step S104 is performed; if “no”, the method returns to step S110.

S104: The method determines whether the state is the constant-current state.

If “yes”, step S105 is performed; if “no”, the method returns to step S111.

S105: The selection instruction input by the user is received.

Selection instruction input by the user via at least one of the touch screen, microphone or keyboard may be received. The detailed description can refer to the second embodiment of the charging method of the invention.

S106: The method determines whether the selection instruction is valid.

If “yes”, step S107 is performed; if “no”, the method returns to step S108.

S107: The selection instruction is analyzed.

If the selection instruction indicates fast-charging, step S109 is performed; if the selection instruction indicates slow-charging, step S110 is performed.

S108: The charging scheme is selected by the smart selection.

If the fast charging is selected, step S109 is performed; if the slow charging is selected, step S110 is performed.

S109: The fast charging scheme is adopted to perform the constant-current charging. The fast charging scheme has a higher charging current relative to the slow charging scheme. When the constant-current charging has finished, step S111 is performed.

S110: The slow charging scheme is adopted to perform the constant-current charging. When the constant-current charging has finished, step S111 is performed.

S111: The constant-voltage charging is performed. When the constant-voltage charging has finished, step S112 is performed.

S112: The charging has finished.

The process is terminated.

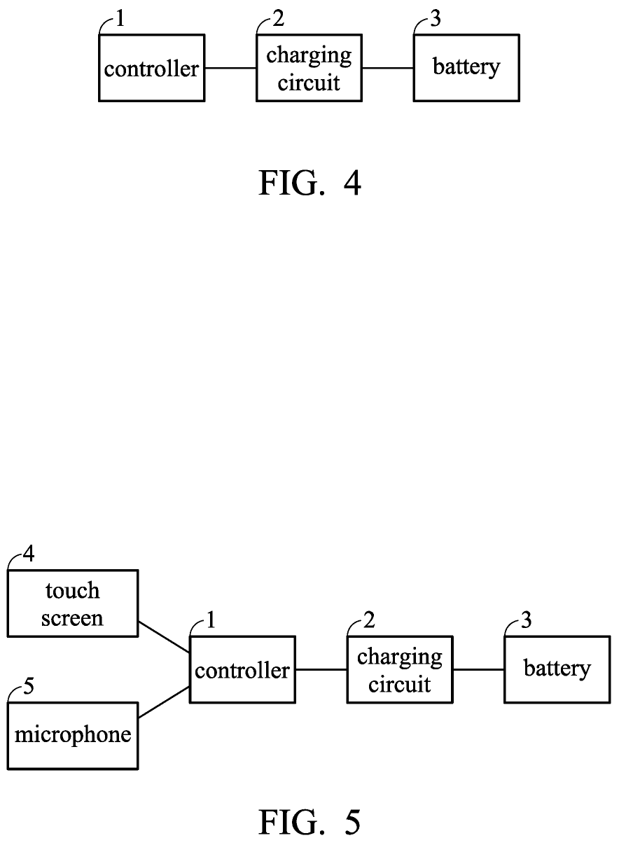

As shown in FIG. 4, a first embodiment of the electronic apparatus of the invention comprises a controller 1, a charging circuit 2, and a battery 3, wherein the controller 1, the charging circuit 2, and the battery 3 are connected to each other.

The controller 1 is configured to select a charging scheme from at least one of the first charging scheme and the second charging scheme, and to control the charging circuit 2 to charge the battery 3 according to the selected charging scheme, wherein the charging speeds of the first charging scheme and the second charging scheme are different. The details are available in the first embodiment of the charging method of the invention addressed above, and will not be described again here for brevity.

According to the above embodiment, when the user needs fast-charging, e.g. when the user goes out, battery power is not sufficient, and the fast charging scheme will be selected. In other situations, when the user is not concerned with the charging speed, e.g. at the user's bedtime, the slow charging scheme will be selected. Therefore, when the user needs fast-charging, the fast charging scheme will be adopted according to the user's requirement, and during a non-fast charging time, the slow charging scheme will be adopted to decrease the degradation of the electrical quantity of the battery and slow down the battery's aging.

As shown in FIG. 5, a second embodiment of the electronic apparatus of the invention is based on the first embodiment of the electronic apparatus of the invention. The second embodiment of the electronic apparatus further comprises a touch screen 4 and a microphone 5. The touch screen 4 and the microphone 5 are connected to the controller 1.

The controller 1 is configured to receive the selection instruction to select the charging scheme that corresponds to the selection instruction, wherein the selection instruction is input by the user through the touch screen 4 and the microphone 5. The details are available in the first embodiment of the charging method of the invention addressed above, and will not be described again here for brevity.

In the first embodiment of the electronic device of the invention, the controller 1 is configured to match at least one of these parameters, such as the current time, current location, user habit, and battery loading with the default settings of each charging scheme to select a charging scheme. The settings may be by default, may be rules set by the user, or may be set according to the user's selection history of previous selections of the charging methods. For example, at night, the charging scheme with a slow charging speed may be selected, but in the daytime, the charging scheme with a fast charging speed may be selected; or at home, the charging scheme with a slow charging speed may be selected, but in the workplace, the charging scheme with a fast charging speed may be selected. When multiple parameters are utilized to be matched with the settings, different parameters may have different priorities or may have the same priority.

The embodiment in the above paragraph may be combined with the first embodiment of the electronic apparatus of the invention and the second embodiment of the electronic apparatus of the invention. When the embodiment is combined with the second embodiment of the electronic apparatus of the invention, the priority of the switch used to select the charging scheme is lower than the selection instruction of the user, i.e. only when the selection instruction of the user cannot be received, or the input selection instruction is invalid, the smart selection can be selected to select the charging scheme. When the charging mode is smart selection, the electronic apparatus will perform smart selection directly without receiving a selection instruction input by the user.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A charging method, comprising:
selecting a charging scheme from at least one of a first charging scheme and a second charging scheme, wherein charging speed of the first charging scheme is different from charging speed of the second charging scheme; and
charging a battery according to the selected charging scheme.

2. The charging method of claim 1, wherein the step of selecting the charging scheme from at least one of the first charging scheme and the second charging scheme comprises:
receiving a selection instruction input by an user; and
selecting the charging scheme that corresponds to the selection instruction.

3. The charging method of claim 2, wherein the step of receiving the selection instruction input by the user comprises:
receiving the selection instruction input by the user through a touch screen and/or a microphone.

4. The charging method of claim 3, wherein the step of receiving the selection instruction input by the user comprises:
obtaining a status of a switch on a charger and selecting the charging scheme according to the status when the selection instruction of the user cannot be received, the input selection instruction is invalid, or a charging mode is smart charging mode, wherein the switch is configured to select the charging scheme.

5. The charging method of claim 2, wherein the step of selecting the charging scheme from at least one of the first charging scheme and the second charging scheme comprises:
matching at least one of a current time, a current location, a user habit, and a battery loading with default settings of each charging scheme to select a charging scheme when the selection instruction of the user cannot be received, the input selection instruction is invalid, or the charging mode is smart charging mode.

6. The charging method of claim 1, wherein the step of selecting the charging scheme from at least one of the first charging scheme and the second charging scheme comprises:
matching at least one of a current time, a current location, a user habit, and a battery loading with default settings of each charging scheme to select the charging scheme.

7. The charging method of claim 1, wherein the step of selecting the charging scheme from at least one of the first charging scheme and the second charging scheme comprises:
selecting the charging scheme according to the status of a switch on a charger, wherein the switch is configured to select the charging scheme.

8. An electronic apparatus, comprising
a controller;
a charging circuit; and
a battery, wherein the controller, the charging circuit and the battery are connected to each other,
wherein the controller selects a charging scheme from at least one of a first charging scheme and a second charging scheme and controls the charging circuit according to the selected charging scheme to charge the battery, wherein charging speed of the first charging scheme is different from charging speed of the second charging scheme.

9. The electronic apparatus of claim 8, further comprising:
a touch screen; and
a microphone,
wherein the controller receives the selection instruction input by an user through the touch screen and/or the microphone to select the charging scheme that corresponds to the selection instruction.

10. The electronic apparatus of claim 8, wherein the controller matches at least one of a current time, a current location, a user habit, and a battery loading with default settings of each charging scheme to select the charging scheme.
